(19) United States
(12) Patent Application Publication
(10) Pub. No.: US 2026/0097990 A1
(43) Pub. Date: Apr. 9, 2026

(54) AVOIDING OF EMISSIONS IN THE PRODUCTION OF ARTIFICIAL POZZOLANS MADE OF MINERAL MATERIAL, IN PARTICULAR CLAYS

(71) Applicants: thyssenkrupp Polysius GmbH, Beckum (DE); thyssenkrupp AG, Essen (DE)

(72) Inventors: Guido GRUND, Werl (DE); Dirk SCHEFER, Ennigerloh (DE); Melanie FLASSPOEHLER, Dortmund (DE); Eugen WAGNER, Werl (DE)

(73) Assignees: thyssenkrupp Polysius GmbH, Beckum (DE); thyssenkrupp AG, Essen (DE)

(21) Appl. No.: 19/112,905

(22) PCT Filed: Sep. 12, 2023
(86) PCT No.: PCT/EP2023/074967

§ 371 Date: Mar. 18, 2025

(30) Foreign Application Priority Data
Sep. 19, 2022 (DE) 10 2022 209 826.9
Sep. 19, 2022 (LU) LU 103008

(51) Int. Cl. C04B 7/47; C04B 7/12; C04B 7/36; C04B 7/43; C04B 7/44; F23J 7/00; F23J 15/02; F23K 5/00; F23N 1/00; F27B 7/10; F27B 7/34; F27D 17/17; F27D 17/18; F27D 17/20

(52) U.S. Cl. CPC C04B 7/475; C04B 7/12; C04B 7/361; C04B 7/364; C04B 7/432; C04B 7/44; F23J 7/00; F23J 15/02; F23K 5/007; F23N 1/002; F27B 7/10; F27B 7/34; F27D 17/17; F27D 17/18; F27D 17/20; F23J 2219/10; F23N 2225/08; F23N 2900/05003; F27M 2003/03

(57) ABSTRACT

A device for thermal treatment comprises at least a preheater, a calciner, and a materials cooler, wherein a solids stream is guided into the preheater, from the preheater into the calciner, from the calciner into the materials cooler, and out of the materials cooler, wherein a gas stream is guided into the materials cooler, from the materials cooler into the calciner, from the calciner into the preheater, and out of the preheater, wherein the device comprises a combustion chamber, wherein the gas stream from the materials cooler is guided at least partially through the combustion chamber into the calciner, wherein a residence time device is arranged between the combustion chamber and the calciner.

The invention relates to a device and a method with which an offgas treatment for the conversion of pollutants is possible within the process itself and thus without downstream offgas treatment, which in turn reduces or avoids the energy consumption for an offgas treatment.

Substitute fuels are increasingly being used to replace primary raw materials, such as coal dust, for example, and so in particular to contribute to climate neutrality. However, substitute fuels are often relatively resistant to ignition and are required, not least because of statutory requirements, to have a minimum burning time and a minimum burning temperature. Therefore, such substitute fuels are often burned in combustion chambers attached at the side of the actual treatment device. This has the advantage of very direct connection between heat generation in the combustion chamber and heat consumption by the reaction in the treatment device.

The combustion of heating fuels is accompanied by formation, for example, of nitrogen oxides, summarized for short as NOₓ, and also partially unburned hydrocarbons and hydrocarbon-containing compounds, summarized here and below for simplification (and disregarding further heteroatoms) as CₓH_{y}. NOₓ can be converted to nitrogen either non-catalytically (SNCR) or catalytically (SCR), in particular with ammonia NH₃ or urea. Hydrocarbon CₓH_{y} can be converted with oxygen to water and carbon dioxide. A temperature window of more than 800° C. is useful for this conversion. It is typically necessary in offgas treatment, therefore, to reheat the comparatively cold offgases, which consumes energy and often necessitates additional heat exchangers.

A method for producing a clinker substitute is known from DE 10 2011 014 498 A1.

A production process for synthetic pozzolans is known from U.S. Pat. No. 9,458,059 B2.

A method for producing artificial pozzolans is known from WO 2012/082683 A1.

A plant and a method for producing cement clinker are in WO 2005/108891 A1.

A method and a device for reducing gases containing NOx in offgases from a rotary kiln are known from EP 2 587 149 A1.

The temperature control of a calciner is known from EP 1 898 171 A1.

It is an object of the invention to save energy in the offgas treatment and thus to avoid further CO₂ emissions, from the combustion of fuels as a heat source, for example.

This object is achieved by the apparatus having the features specified in claim 1 and by the process having the features specified in claim 20. Advantageous developments are apparent from the dependent claims, the description which follows, and the drawing.

The device of the invention is used for the thermal treatment, for example and in particular, of mineral material, especially clays, for the production of artificial pozzolans as an additive for cement clinker. Clays have increasingly become established as an important raw material in the cement industry, as less or no CO₂ is released from the raw material during its thermal treatment, as is the case, for example, when limestone is burned. However, since the temperature for the activation of mineral materials, especially clays, can often be below 800° C., the temperature inside the calciner is not sufficient to reliably convert pollutants. The device comprises at least a preheater, a calciner and a materials cooler. The preheater is configured, for example, as a cocurrent heat exchanger with cyclone separator or as a cascade of two to six cocurrent heat exchangers with cyclone separator. Alternatively, the preheater can also be configured as a cross-flow heat exchanger. The materials cooler is likewise preferably configured as a cocurrent heat exchanger with cyclone separator or as a cascade of two to six cocurrent heat exchangers with cyclone separator. Alternatively, the materials cooler can also be configured as a cross-flow heat exchanger. A solids stream is guided into the preheater, from the preheater into the calciner, from the calciner into the materials cooler, and out of the materials cooler. In countercurrent to this, a gas stream is guided into the materials cooler, from the materials cooler into the calciner, from the calciner into the preheater, and out of the preheater. The device comprises a combustion chamber. The gas stream from the materials cooler is guided at least partially through the combustion chamber into the calciner. There may be another partial stream, guided for example directly from the materials cooler into the calciner, meaning that there is a combustion chamber bypass. In the combustion chamber, the thermal energy required for the process is provided by the combustion of natural gas, hydrogen, coal, ammonia or substitute fuels, such as biomass, used tires or household garbage, for example. Plants of these kinds are known for the thermal treatment of mineral substances, especially clays.

In accordance with the invention, a residence time device is now arranged between the combustion chamber and the calciner, and so the combustion chamber is arranged outside the solids stream. Pollutants are formed in the combustion chamber, for example NOₓ at the temperatures of combustion. Hydrocarbons and hydrocarbon-containing compounds may also escape from the combustion material here. This may be a relevant issue, especially when using substitute fuels. The combustion chamber is typically arranged either within the calciner, in the case of natural gas firing, for example, or directly at the calciner, in particular for substitute fuels. The direct connection on the one hand prevents heat losses and additionally saves investment costs and construction space. The heat is thus generated as close as possible to the place where it is needed for the intended reaction. At the same time, this achieves a higher temperature constancy in the region of the reaction in a simple way. Therefore it initially appears not to be advantageous to spatially separate the combustion chamber and the calciner and arrange a residence time device in between and so to arrange the combustion chamber clearly separate from the solids stream and thus from the location of the energy sink for the reaction. However, doing so makes it possible to treat the offgases from the combustion chamber at an ideal temperature level and thus avoid downstream and energy-intensive offgas treatment. In addition, the offgases are treated separately from the solids stream and before the hot offgases meet the solids stream. Through the residence time device, it is possible to separate the temperatures for the offgas treatment in the residence time device and the thermal treatment, of the clay for example, in the calciner, and so a suitable temperature window can be selected in each case both for the offgas treatment and for the thermal treatment. In particular, the temperature in the residence time device can be selected higher than in the calciner, so that in this case combustion of CₓH_{y} in particular with oxygen can take place or in the presence of, for example, ammonia, NOₓ can be reacted by synproportionation of NOₓ and NH₃ to give nitrogen (and water). The nature of the pollutants is typically very dependent on the type of fuel used.

The residence time device as well is preferably arranged completely outside the solids stream, although at the connection between the residence time device and the calciner a certain level of backmixing can of course not be excluded. However, the net gas stream is directed completely from the combustion chamber to the calciner.

In a further embodiment of the invention, an auxiliary combustion device is arranged between the combustion chamber and the residence time device and/or in the residence time device. This embodiment is preferred if the combustion chamber is configured for the combustion of substitute fuels. Substitute fuels typically exhibit greater fluctuation in the calorific value. The auxiliary combustion device is preferably configured for the combustion of a fuel which enables rapid and selectively adaptable combustion. The auxiliary combustion device is preferably configured to burn a fuel which is selected from the group encompassing coal dust, natural gas, hydrogen, biogas and ammonia. Hence it is possible to compensate for temperature fluctuations caused by fluctuations in the fuel material in the combustion chamber in a targeted and rapid manner, so that a stable temperature is ensured in the residence time device and thus the process of pollutant depletion takes place reliably.

In a further embodiment of the invention, the residence time device is tubular. For example, the tubular residence time device may have a gooseneck-shaped configuration. The tubular residence time device may also be configured as an expanded conduit. The residence time device may optionally be equipped with one or more flow internals which improve intensive mixing of the gas within the apparatus.

In a further embodiment of the invention, a first reactant feed is arranged between the combustion chamber and the residence time device. The reactant feed is used to supply a reactant for the conversion of pollutants. Since the pollutants to be treated are very dependent on the fuel burned in the combustion chamber, the reactant and thus the first reactant feed should be selected depending on the fuel to be used in the combustion chamber.

In a further embodiment of the invention, the first reactant feed is configured for supplying oxygen, including for example in the form of air or of air preheated in the materials cooler. Oxygen is required as a reaction partner for the conversion of hydrocarbon CₓH_{y} to water and carbon dioxide.

In a further embodiment of the invention, the first reactant feed is configured for supplying various types of reducing agent, for example ammonia, urea, compounds thereof or solutions, more particularly aqueous solutions, of these. Ammonia or urea can undergo synproportionation with nitrogen oxides NOx to give nitrogen.

In a further embodiment of the invention, the device comprises at least one first NOₓ analyzer. The NOₓ analyzer is used to detect the NOₓ concentration. Typically, a device utilizing infrared spectroscopy is used as NOₓ analyzer. The at least one first NOₓ analyzer is arranged in one embodiment in the residence time device or between the residence time device and the calciner. This has the advantage of immediate feedback and faster regulatability. In addition or alternatively, the at least one first or a second NOₓ analyzer may be arranged in or downstream of the preheater. The advantage of this embodiment is that the gases here are much cooler, which simplifies the measurement. The at least one first or a second NOₓ analyzer may also be arranged after the calciner or even after the preheater, since in these the temperature should no longer be high enough for formation of NOₓ, meaning, therefore, that this value too is meaningful for the NOₓ content in the residence time device.

In a further embodiment of the invention, the device comprises at least one first NH₃ analyzer. The NH₃ analyzer is used to detect the NH₃ concentration in the gas stream. Preferably, a plurality of NH₃ analyzers are used to determine the concentration at different points in the offgas stream path. The one or the at least two NH₃ analyzers are located, for example, in different levels of the calciner and regulate/control the addition of the reactant so as to determine the utilization of the reactant and thus ensure effective utilization of the reactant. The at least one NH₃ analyzer, preferably the at least two NH₃ analyzers, are located, for example and preferably, in close proximity to the at least one NOx analyzer and/or at least one temperature sensor. The NH₃ analyzer or analyzers are connected via at least one metering system to corresponding containers, preferably to at least one container for ammonia. Thus ammonia, for example, can be injected into the gas stream at different points and/or levels in the same or different amount and/or concentration.

In a further embodiment of the invention, the device comprises at least one first control device. The at least one first control device is configured for reading the at least one first NOₓ analyzer. The at least one first control device is implemented/configured for actuating the first reactant feed and/or an optional second reactant feed in dependence on the NOₓ value detected by at least one first NOₓ analyzer and regulates the first reactant feed and/or the optional at least one further reactant feed, preferably in different levels and/or with multiple nozzles, in dependence on the NOₓ value detected. This enables targeted addition of the reactant, for example of ammonia, whereby in turn overdosing of the reactant and associated emission of ammonia, for example, can be avoided.

In a further embodiment of the invention, the device comprises at least one first control device. The at least one first control device is configured for reading the at least one first NH₃ analyzer. The at least one first control device is configured for actuating the first reactant feed and/or at least one further reactant feed in dependence on the NH₃ value detected by at least one first NH₃ analyzer and regulates the first reactant feed and/or the at least one optional second reactant feed in dependence on the NH₃ value detected. This enables targeted addition of the reactant, for example of ammonia, whereby in turn overdosing of the reactant and associated emission of ammonia, for example, can be avoided.

In a further embodiment of the invention, the device comprises a temperature sensor. Temperature sensor is to be understood broadly within the meaning of the invention and embraces any sensor system for temperature detection. The temperature sensor may be a thermocouple. Alternatively, a temperature sensor may also be an acoustic sensor, which determines the temperature over a spatial distance by means of the speed of sound. The temperature sensor is preferably arranged in the first combustion chamber, in the residence time device or between the combustion chamber and the residence time device. The device may also have a plurality of temperature sensors, in particular at the aforementioned positions.

In a further embodiment of the invention, the device comprises at least one first control device. The at least one first control device is configured for reading the temperature sensor or the temperature sensors. The at least one first control device is configured for actuating the first reactant feed and/or an at least optional second reactant feed and/or the auxiliary combustion device in dependence on the temperature detected by the temperature sensor. This allows a targeted addition of a fuel, which in turn allows an exact adaptation of the temperature to the desired temperature window.

In a further embodiment of the invention, the first reactant feed is designed for supply at a pressure of 0.5 bar to 5 bar.

In a further embodiment of the invention, a first water feed is arranged adjacent to the first reactant feed. The injection of water through the water feed can be utilized for targeted temperature adjustment in order to optimally adjust the temperature level for pollutant minimization. The water feed is typically used not only for the supply of water; typically, aqueous solutions, more particularly process wastewaters, are used, which may additionally contain further substances. The calorific value of the further substances is preferably not so high that it compensates the cooling effect which is caused by the evaporation of the water. Thus, for example, aqueous solutions with a proportion of organic compounds can be used here, as the organic compounds are reliably converted under the prevailing conditions.

In a further embodiment of the invention, the device comprises at least one first control device. The at least one first control device is configured for reading the temperature sensor or the temperature sensors. The at least one first control device is configured for actuating the water feed in dependence on the temperature detected by the temperature sensor. This allows a targeted adaptation of the temperature to the desired temperature window.

In a further embodiment of the invention, the residence time device has a length, so that the residence time in the residence time device is between 0.5 s and 10 s, more particularly between 1 s and 5 s, particularly preferably from 1.5 s to 2.5 s. This affords a suitable window between sufficient reaction time and also heat loss and flow resistance.

In a further embodiment of the invention, a reduction device is arranged between the calciner and the materials cooler. A reduction device is used for treating the thermally treated material in a reducing atmosphere, in particular for color optimization. To form the reducing atmosphere it is possible for example to use gases, solids and/or liquids, comprising, for example, carbon, hydrogen, nitrogen, carbon monoxide or the like or corresponding compounds thereof, for example methane or ammonia or mixtures thereof, and additionally inert gases as well, especially nitrogen. The reducing atmosphere can also be generated by a substoichiometric combustion (deficit of oxygen). For example, Fe^{III} can be reduced to Fe^{II} in this way, which leads to color reduction in the product and thus to increased market acceptance.

In a further embodiment of the invention, the residence time device comprises a catalyst. The catalyst is, for example, a platinum-rhodium catalyst which is suitable for the conversion of NOₓ and NH₃ to nitrogen.

In a further embodiment of the invention, the residence time device comprises at least one diversion. Alternatively or in addition, the residence time device comprises flow internals for gas mixing. In particular, the residence time device can be designed with a gooseneck shape. As well as the compact spatial arrangement, the diversions result in mixing. In addition, this also allows height differences to be compensated, which promotes a compact design.

In a further embodiment of the invention, the residence time device comprises at least one second reactant feed. The at least second reactant feed is arranged between the combustion chamber and the residence time device or at the residence time device and preferably connected to an optional control apparatus. In a first case, the first reactant feed and the at least second reactant feed are configured for the supply of the same reactant. For example, both can be configured for the supply of ammonia. In particular, therefore, the first reactant feed and the at least second reactant feed are spaced apart from one another. This allows the concentration, of the ammonia for NOx depletion for example, to be kept more constant. In a second case, the first reactant feed serves for supplying a first reactant, for example NH₃ for the depletion of NOₓ, and the at least second reactant feed serves for supplying at least one second reactant, for example O₂ or air for the depletion of CₓH_{y}.

In a further embodiment of the invention, the device comprises an SCR reactor, wherein the SCR reactor is arranged in the gas stream downstream of the preheater. The SCR reactor can be used in particular as a backup solution. As long as the NOₓ reduction in accordance with the invention is sufficient, the SCR reactor, for example, is not operated and thus the required energy is saved.

In a further embodiment of the invention, the device has a bypass, wherein the bypass is arranged between the combustion chamber and the calciner. The bypass is arranged fluidically parallel to the residence time device. Thus, a first partial stream is guided through the residence time device and a second partial stream is guided through the bypass. This enables optimal utilization of the permissible emissions.

In a further aspect, the invention relates to a method for operating a device of the invention. The temperature selected in the residence time device is between 750° C. and 1300° C. In particular, the selected temperature in the residence time device is between 800° C. and 1100° C., particularly preferably between 900° C. and 1050° C.

In a further embodiment of the invention, thermal treatment of mineral material, more particularly clays or claylike substances, takes place.

The device of the invention is more closely elucidated hereinbelow with reference to an exemplary embodiment represented in the drawing.

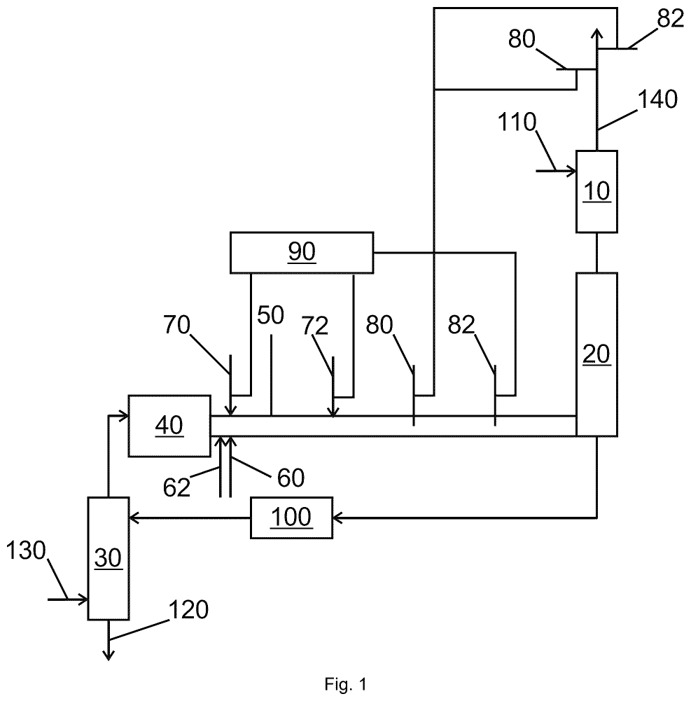

FIG. 1 Device.

FIG. 1 provides a schematic representation of an illustrative device. The material to be treated, a clay for example, is supplied to the preheater 10 via a materials feed 110, introduced preheated into the calciner 20, and thermally treated there. From the calciner 20, the material enters an optional reduction device 100, where it undergoes optimization for color in particular, and enters the materials cooler 30, from which the finished product is then withdrawn via a product offtake 120. In countercurrent, the gas is guided via a gas supply 130 first into the materials cooler 30 and heated there by the product to be cooled. The heated gas enters the combustion chamber 40. There, for example, a substitute fuel, such as garbage, is burned. During combustion, nitrogen oxides can be produced solely due to the temperature and the presence of nitrogen and oxygen. Combustion chamber (40) and residence time device (50) are preferably equipped with temperature sensors. Furthermore, the gases are hottest on leaving the combustion chamber 40, and so this moment is ideally suited for decomposing the nitrogen oxides again. In order to compensate for fluctuations in the calorific value of the secondary fuel, the device comprises an auxiliary combustion device 60 (optionally a plurality of auxiliary combustion devices 60), which is operated, for example, with gas, liquid fuel or coal dust and is thus able to reliably adjust the temperature. In addition, the plant comprises a water feed 62, with which water can be supplied and thus the temperature can be lowered in a simple way. The combination of auxiliary combustion device 60 and water feed 62 thus enables particularly selective temperature adjustment. In addition, an ammonia solution is injected via a first reactant feed 70. As a result, a reaction between NOₓ and NH₃ can take place in the residence time device 50 at for example 1000° C. In order to complete the reaction and not to generate an excess of ammonia (and thus introduce a new pollutant source), the device also comprises a second reactant feed 72, in which ammonia solution is injected again at a later point in the residence time device 50. In addition, an NOₓ analyzer 80 and an NH₃ analyzer (82) are arranged in the residence time device. In addition, an NOₓ analyzer 80 and an NH₃ analyzer (82) are arranged after the preheater. The NOₓ analyzers 80 and the NH₃ analyzers (82) are connected to a first control device 90, which regulates the injection of ammonia solution through the first reactant feed 70 and the second reactant feed 72 in dependence on the NOₓ content detected by the NOx analyzer 80 and the NH₃ content detected by the NH₃ analyzer and also the temperature level detected via temperature sensors. From there, the hot gas, but freed of NOx and with only low NH₃ content, enters the calciner 20. For certain products the calciner can be operated for example at 750° C., which would however be too low to convert NOₓ within the calciner 20. The gas is guided from the calciner 20 into the preheater 10, where it delivers its heat to the material supplied. The offgas from the preheater 10 is then delivered via a gas drain 140 and can be supplied, for example, to a further treatment, for dedusting, for example.

### Reference Signs

10 preheater
20 calciner
30 materials cooler
40 combustion chamber
50 residence time device
60 auxiliary combustion device
62 water feed
70 first reactant feed
72 second reactant feed
80 NOₓ analyzer
82 NH₃ analyzer
90 control device
100 reduction device
110 materials feed
120 product offtake
130 gas supply
140 gas drain

1-22. (canceled)

23. A device for thermal treatment of mineral materials, comprising:
a preheater;
a calciner;
a materials cooler, wherein a solids stream extends into the preheater, from the preheater into the calciner, from the calciner into the materials cooler, and out of the materials cooler, and wherein a gas stream extends into the materials cooler, from the materials cooler into the calciner, from the calciner into the preheater, and out of the preheater; and
a combustion chamber, wherein the gas stream extends from the materials cooler at least partially through the combustion chamber into the calciner, wherein a residence time device is arranged between the combustion chamber and the calciner, and the combustion chamber is arranged outside the solids stream.

24. The device as claimed in claim 23, wherein at least one auxiliary combustion device is arranged between the combustion chamber and the residence time device and/or in the residence time device.

25. The device as claimed in claim 23, wherein a first reactant feed is arranged between the combustion chamber and the residence time device.

26. The device as claimed in claim 25, wherein at least the first reactant feed is configured for the supply of ammonia, urea, compounds thereof or solutions of these.

27. The device as claimed in claim 26, wherein the device comprises at least one first NOₓ analyzer and the device comprises at least one first control device, wherein the at least one first control device is configured for reading the at least one first NOₓ analyzer, wherein the at least one first control device is configured for actuating at least one first reactant feed in dependence on the NOₓ value detected by at least one first NOₓ analyzer by adapting the type and/or amount and/or concentration of the reactant.

28. The device as claimed in claim 27, wherein the device comprises at least one temperature sensor and the at least one first control device is configured for reading the temperature sensor, wherein the at least one first control device is configured for actuating at least one first reactant feed and/or at least one auxiliary combustion device and/or at least one water feed in dependence on the temperature detected by the temperature sensor by adapting the type and/or amount and/or concentration of the reactant.

29. The device as claimed in claim 28, wherein the device comprises at least one NH₃ analyzer and the at least one first control device is configured for reading the at least one first NH₃ analyzer, wherein the at least one first control device is configured for actuating at least one first reactant feed in dependence on the NH₃ value detected by at least one first NH₃ analyzer by adapting the type and/or amount and/or concentration of the reactant.

30. The device as claimed in claim 29, wherein the reactant feed is mounted at at least one addition point, in at least one height plane.

31. The device as claimed in claim 30, wherein the reactant feed is mounted at at least two addition points, in at least two different height planes.

32. The device as claimed in claim 31, wherein the first reactant feed is designed for a feed with a pressure of 0.5 bar to 5 bar and at least one first water feed is arranged adjacent to the first reactant feed.

33. The device as claimed in claim 23, wherein the residence time device has a length, so that the residence time in the residence time device is between 0.5 s and 10 s.

34. The device as claimed in claim 23, wherein the residence time device has a length, so that the residence time in the residence time device is between 1 s and 5 s.

35. The device as claimed in claim 23, wherein the residence time device has a length, so that the residence time in the residence time device is between 1.5 s and 2.5 s.

36. The device as claimed in claim 23, wherein a reduction device is arranged between the calciner and the materials cooler.

37. The device as claimed in claim 23, wherein the residence time device comprises a catalyst and also comprises at least one diversion and/or flow internals for the gas mixture.

38. The device as claimed in claim 23, wherein the residence time device comprises at least one second reactant feed, wherein the second reactant feed is arranged between the combustion chamber and the residence time device or at the residence time device.

39. The device as claimed in claim 23, wherein the device comprises a catalytic reactor, wherein the catalytic reactor is arranged in the gas stream downstream of the preheater.

40. A method for operating a device as claimed in claim 23, wherein a temperature in the residence time device is between 750° C. and 1300° C.

41. The method as claimed in claim 40, wherein the temperature in the residence time device is between 900° C. and 1050° C.

42. The method as claimed in claim 40, wherein a thermal treatment of clays or claylike substances takes place.
